(19) United States
(12) Patent Application Publication
(10) Pub. No.: US 2006/0190733 A1
(43) Pub. Date: Aug. 24, 2006

(54) Methods and apparatus for resource management in a processor

(75) Inventor: Akiyuki Hatakeyama, Kanagawa (JP)

Correspondence Address: KAPLAN GILMAN GIBSON & DERNIER L.L.P., 900 ROUTE 9 NORTH, WOODBRIDGE, NJ, 07095, US

(73) Assignee: Sony Computer Entertainment Inc., Minato-ku (JP)

(21) Appl. No.: 11/347,618

(22) Filed: Feb. 3, 2006

Related U.S. Application Data
(60) Provisional application No. 60/650,750, filed on Feb. 7, 2005.

(51) Int. Cl. H04L 9/00

(52) U.S. Cl. 713/176; 713/182

(57) ABSTRACT

Methods and apparatus provide for receiving encrypted content including program code, data, and a digital signature in a memory of a processing system, the content being encrypted using a first key; decrypting the encrypted content using a second key stored locally within the processing system; retrieving the digital signature from the content and verifying its authenticity; and permitting use of one or more processing resources that are operable to facilitate the execution of the program code by a processor of the processing system if the digital signature is authentic.

### CROSS REFERENCE TO RELATED APPLICATION

This application claims the benefit of U.S. Provisional Patent Application No. 60/650,750, filed Feb. 7, 2005, entitled “Methods And Apparatus For Resource Management In A Processor,” the entire disclosure of which is hereby incorporated by reference.

### BACKGROUND OF THE INVENTION

The present invention relates to methods and apparatus for managing processing resources in a processing system to achieve desirable business goals.

In recent years, there has been an insatiable desire for faster computer processing data throughputs because cutting-edge computer applications are becoming more and more complex, and are placing ever increasing demands on processing systems. Graphics applications are among those that place the highest demands on a processing system because they require such vast numbers of data accesses, data computations, and data manipulations in relatively short periods of time to achieve desirable visual results.

Designers and manufacturers of processing systems are meeting the challenge to achieve faster processing speeds such that more and more complex software applications may be executed. A conventional business model dictates that the designer/manufacturer of the processing system may obtain a price commensurate with the capabilities of the system from a user seeking to purchase the processing system and execute content (e.g., programs) thereon. The conventional business model also dictates that the content may be developed by a third party or by the designer/manufacturer of the processing system. The designer/manufacturer may also license the third party to develop content for execution on the processing system.

Depending on the processing system architecture and the operating system running thereon, conventional business models and processing system designs cannot guarantee that a third party can be prevented from developing content for execution on the processing system unless a license or other form of compensation is obtained. For example, it may be desirable to have an open system architecture (hardware and software) in order to encourage the development of newer and more advanced content for enjoyment by the user. Unfortunately, an open system architecture does not provide many opportunities for controlling the execution of the content on the processing system by the designer/manufacturer. Thus, the designer/manufacturer may find it difficult to share in the profits of content sales.

Accordingly, there are needs in the art for new methods and apparatus for managing processing resources in a processing system such that the advantages of an open system architecture may be realized while also permitting the designer/manufacturer of the processing system to share in the rewards of content development and sales.

### SUMMARY OF THE INVENTION

One or more aspects of the invention are directed to a processing system in which the ability of an application program to utilize the resources of the processing system are strictly regulated by the operating system of the processing system. Some of the resources of a processing system, such as a video game console, include a disc controller (CD, DVD, etc.), graphics chips, hard disc (HD) components, tuner circuitry, network interface circuitry, etc. In accordance with some embodiments of the invention, content providers (such as game developers, etc.) must purchase the ability to use certain resources of the processing system upon which they wish to have their content executed. The purchase may take on many different forms, such as a one-time payment, a royalty-based payment schedule, etc. The usage may be unlimited or time limited.

In accordance with one or more aspects of the present invention, the regulation of access to the resources of the processing system may be achieved by requiring the presentation of usage information, such as an authentication code and/or digital signature to the processing system. In return for payment, an authorizing entity (such as the designer/manufacturer of the processing system) may provide a private key of a private/public key pair to the content provider. The provider may run a known hash algorithm on the content to get a hash result and then encrypt the content and the hash result. As the operating system of the processing system may readily control whether certain resources are enabled to a program, the processing system may prevent the content from using certain resources unless: (1) the content and the hash result can be decrypted using the public key of the private/public key pair, and (2) the hash result matches an independently run hash of the content.

In order to ensure that the operating system of the processing system may not be tampered with during the regulation of resources, the processing system is preferably operable to enter a secure mode before the content verification process proceeds.

In accordance with at least one aspect of the present invention, methods and apparatus are operable to permit a processing system to: receive encrypted content including program code, data, and a digital signature in a memory of the processing system, where the content is encrypted using a first key. The content is decrypted using a second key stored locally within the processing system in order to retrieve the digital signature from the content and verify its authenticity. Thereafter, use of one or more processing resources that are operable to facilitate the execution of the program code by a processor of the processing system is permitted if the digital signature is authentic.

The digital signature preferably includes a hash result obtained by running a hash algorithm on at least a portion of the content prior to encrypting the content. The processor preferably: (i) runs the hash algorithm on the portion of the decrypted content to obtain a second hash result, and (ii) compares the hash result of the digital signature with the second hash result to verifying its authenticity.

The content may include a resource list that identifies which of the processing resources is permitted to be used by the program code, and use of the listed processing resources may be permitted by the processor upon verification of the digital signature.

Preferably execution of at least some of the program code is permitted despite absence of and/or a non-authentic digital signature; and use of at least one of the processing resources is permitted despite absence of and/or a non-authentic digital signature.

Other aspects, features, advantages, etc. will become apparent to one skilled in the art when the description of the invention herein is taken in conjunction with the accompanying drawings.

### BRIEF DESCRIPTION OF THE DRAWINGS

For the purposes of illustrating the various aspects of the invention, there are shown in the drawings forms that are presently preferred, it being understood, however, that the invention is not limited to the precise arrangements and instrumentalities shown.

FIG. 1 is a block diagram illustrating a processing system in accordance with one or more aspects of the present invention;

FIG. 2 is a flow diagram illustrating certain actions that may be carried out between a content provider and, for example, a provider of the processing system in accordance with one or more further aspects of the present invention;

FIG. 3 is a block diagram illustrating certain details of content that may be provided by the content provider for execution by the processing system of FIG. 1 in accordance with one or more aspects of the present invention;

FIG. 4 is a flow diagram illustrating process steps that may be carried out by the processing system of FIG. 1 in accordance with one or more further aspects of the present invention; and

FIG. 5 is a diagram illustrating the structure of a multi-processing system having two or more sub-processors, one or more of which may include the capabilities of the processing system of FIG. 1 in accordance with one or more further aspects of the present invention.

### DETAILED DESCRIPTION OF THE PRESENT INVENTION

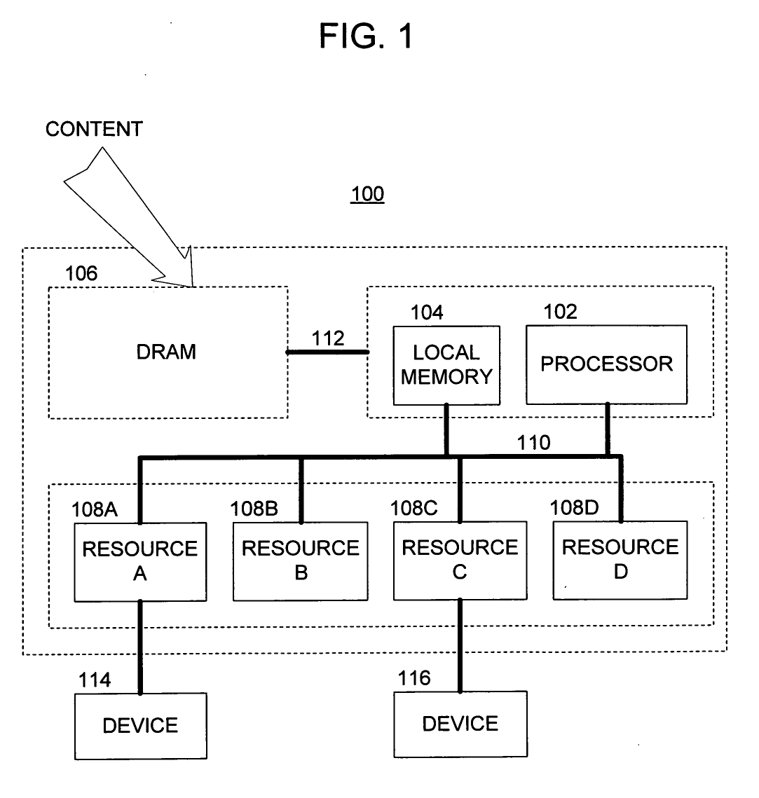

With reference to the drawings, wherein like numerals indicate like elements, there is shown in FIG. 1 a processing system 100 suitable for employing one or more aspects of the present invention. For the purposes of brevity and clarity, the block diagram of FIG. 1 will be referred to and described herein as illustrating an apparatus 100, it being understood, however, that the description may readily be applied to various aspects of a method with equal force. The apparatus 100 preferably includes a processor 102, a local memory 104, a system memory 106 (e.g., a DRAM), and a bus 112 interconnecting same.

The system memory 106 may receive content, such as program code and data, for execution by the processor 102. For example, the processor 102 may cause at least some of the content to be stored within the local memory 104 and then executed in order to achieve a desired result.

The processor 102 may be implemented utilizing any of the known technologies that are capable of requesting data from the system memory 106, and manipulating the data to achieve a desirable result. For example, the processor 102 may be implemented using any of the known microprocessors that are capable of executing software and/or firmware, including standard microprocessors, distributed microprocessors, etc. By way of example, the processor 102 may be a graphics processor that is capable of requesting and manipulating data, such as pixel data, including gray scale information, color information, texture data, polygonal information, video frame information, etc.

Preferably, the local memory 104 is located in the same chip as the processor 102; however, the local memory 104 need not be a traditional hardware cache memory. As on-chip space is often limited, the size of the local memory 104 may be much smaller than the system memory 106. The processor 102 preferably provides data access requests to copy data (which may include program data) from the system memory 106 over the bus 112 into the local memory 104 for program execution and data manipulation. The mechanism for facilitating data access may be implemented utilizing any of the known techniques, such as direct memory access (DMA) techniques.

The apparatus 100 also preferably includes a plurality of processing resources 108, such as resource 108A, resource 108B, resource 108C, resource 108D, etc. These resources may assist the processor 102 in carrying out useful tasks in association with executing the program code. By way of example, the processing resources 108 may include a sub-system of the apparatus 100, such as a non-volatile memory. Examples of non-volatile memory sub-systems include hardware and/or software components of an electromagnetic memory medium (e.g., a floppy disk, a hard disk, etc.), an electronic memory medium (e.g., a programmable read only memory, an EE programmable read only memory, etc.), a silicon memory medium (e.g., a Memory Stick, etc.), an optical memory medium (e.g., a CD-ROM, a DVD-ROM, etc.), an external memory, etc. The resources 108 may also include functional circuits of the apparatus 100, such as a graphics processing circuit, a network interface circuit, a display interface circuit, a printer interface circuit, a local data input and/or output interface, etc. Thus, some of the processing resources 108 may be associated with external devices 114, 116, such as a display screen, a printer, etc.

The apparatus 100 is preferably operable to restrict or regulate the ability of an application program (containing some program code) from utilizing one or more of the programming resources during execution. In particular, the operating system of the processor 102 is preferably operable to prevent the use of one or more of the processing resources 108 that are otherwise operable to facilitate the execution of the program code unless the content includes an authorized digital signature. Preferably, the authorized digital signature may only be obtained from an authorized entity, such as the designer and/or manufacturer of the apparatus 100. For example, the apparatus 100 may be capable of executing video game software and a game developer (content provider) may seek to have its game software executed on the apparatus 100. By requiring that the content include an authorized digital signature, the designer/manufacturer of the apparatus 100 may participate in the sale of the content to the user of the apparatus 100.

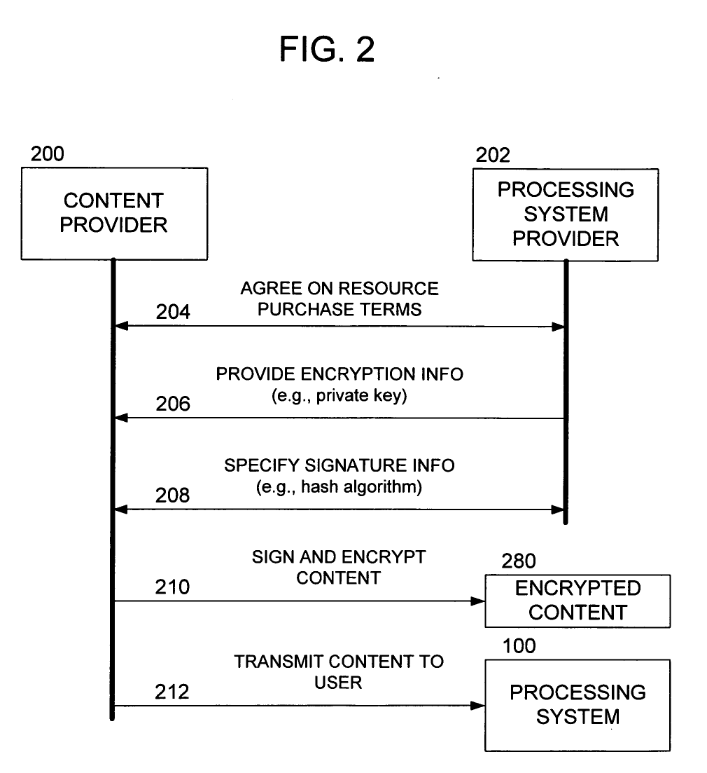

In this regard, reference is made to FIG. 2, which is a flow diagram illustrating actions that may be carried out in accordance with one or more aspects of the present invention. For the purposes of illustration, it is assumed that the apparatus 100 is designed and/or manufactured by a processing system provider 202, and that a content provider 200 seeks to have its software executed on the apparatus 100. At action 204, the content provider 200 and processing system provider 202 agree on purchasing terms by which the software application (program code and data) produced by the content provider 200 may utilize one or more processing resources 108 of the apparatus 100. The purchasing terms may take on any number of forms, such as a one-time payment, a royalty-based payment schedule, etc. The purchasing terms may specify an unlimited usage of the processing resources 108, or the processing terms may provide for a limited number of usages.

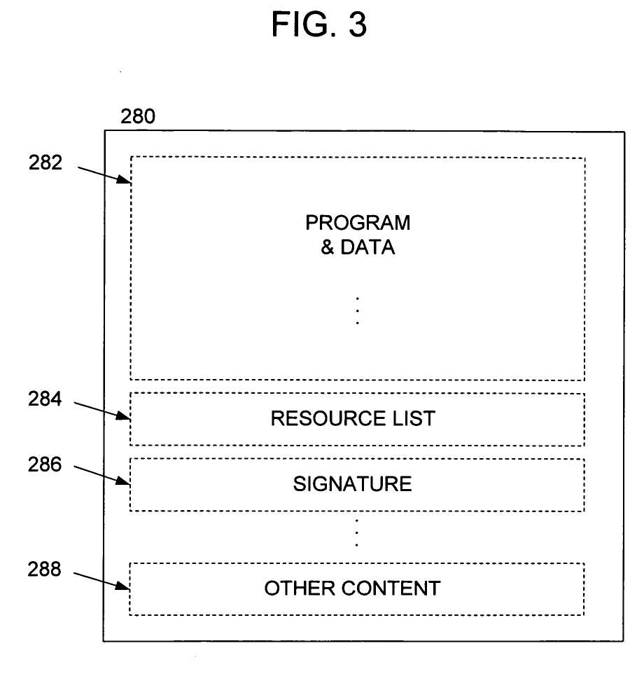

Once the purchasing terms have been agreed upon, the processing system provider 202 preferably makes encryption information available to the content provider 200 (action 206). This encryption information may include, for example, a private key of a private/public key pair that may be used to encrypt the content that is to be provided to the apparatus 100 (and/or the user thereof). At action 208, digital signature information is specified, either by the processing system provider 202 sending such information to the content provider 200 and/or by way of the content provider 200 selecting and/or otherwise specifying desired signature information. For example, with reference to FIG. 3, the content 280 may include program code and data 282, a resource list 284 (which will be discussed in more detail hereinbelow), the digital signature 286, and possibly other content 288.

The digital signature 286 may be obtained by running a hash algorithm on some portion of the content 280. For example, the hash algorithm may be run on the program code and data 282 alone or in combination with the resource list 284. In any case, a hash result obtained by executing the hash algorithm may be utilized as the digital signature 286 that is included with the overall content 280. Turning again to FIG. 2, the processing system provider 202 may specify the particular hash algorithm to be used in producing the digital signature 286. Alternatively, the content provider 200 may select from a list of approved hash algorithms and/or may otherwise specify a desirable hash algorithm to the processing system provider 202.

Actions 204, 206, and 208 represent a request for information by the content provider 200 from the processing system provider 202 in exchange for consideration (e.g., payment) from the content provider 200 in order to permit a software application to utilize one or more resources 108 of the apparatus 100. The particular resources purchased by the content provider 200 may be listed within the resource list 284 and included in the content 280. At action 210, the program code and data 282, the resource list 284, the digital signature 286, and/or the other content 288 are preferably encrypted utilizing the encryption key obtained at action 206. At action 212, the signed and encrypted content 280 may be transmitted or otherwise provided to a user of the apparatus 100.

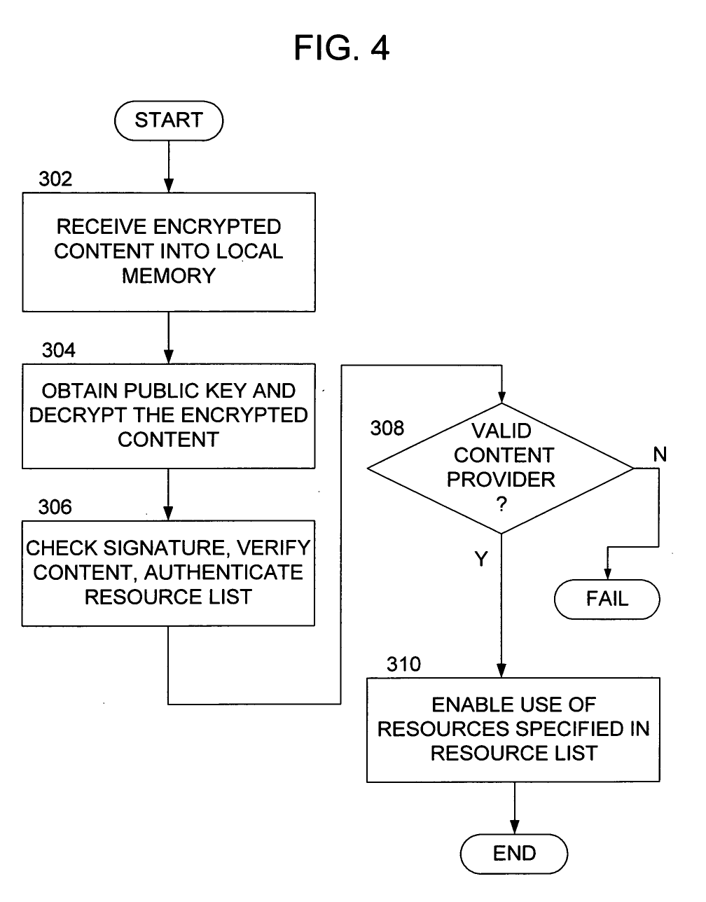

Reference is now made to FIG. 4, which illustrates one or more further actions that may be carried out in accordance with one or more further aspects of the present invention. At action 302, some or all of the encrypted content 280 are preferably received into the local memory 104 (action 302). The apparatus 100 preferably includes a key that corresponds with the key used to encrypt the content 280 prior to its receipt into the system memory 106. For example, the apparatus 100 may include a public key that is used to decrypt the encrypted content 280 (action 304). It is noted that the key stored within the apparatus 100 is preferably stored in a secure fashion such that it may not be readily obtained by those seeking to thwart the security features of the system.

At action 306, the digital signature 286 within the content 280 is preferably checked to determine its authenticity (action 306). For example, if the digital signature 286 is a hash result obtained by running a hash algorithm on at least a portion of the content 280 prior to encryption, then the processor 102 is preferably operable to execute the same hash algorithm on the same portion of the content 280 to produce a second hash result that may be compared with the digital signature 286.

At action 308, a determination is made as to whether the content provider 200 is valid in terms of permitting the content 280 (e.g., the execution of the program code) to utilize one or more of the resources 108 based on whether the digital signature 286 is authentic. If the result of the determination is in the negative, then the process enters a failed state where appropriate action may be taken, such as notifying the user that the content may not be executed, etc. If the result of the determination at action 308 is in the affirmative, then the process flow preferably advances to action 310, where one or more of the resources 108 may be utilized by the program code execution.

In a preferred embodiment, the processor 102 is preferably operable to check the resource list 284 to determine which of the plurality of resources 108 are enabled vis-à-vis the content 280. Thereafter, the specified resources 108 may be utilized in accordance with the agreed upon terms (action 204).

It is noted that in some embodiments of the invention, at least some of the program code may be executed despite the absence of and/or a non-authentic digital signature 286. Further, in accordance with some aspects of the present invention, the use of at least one of the processing resources 108 may be permitted despite the absence of and/or a non-authentic digital signature 286. For example, even with no digital signature, various aspects of the present invention may permit use of resources 108A and 108D but prohibit use of resources 108B and 108C.

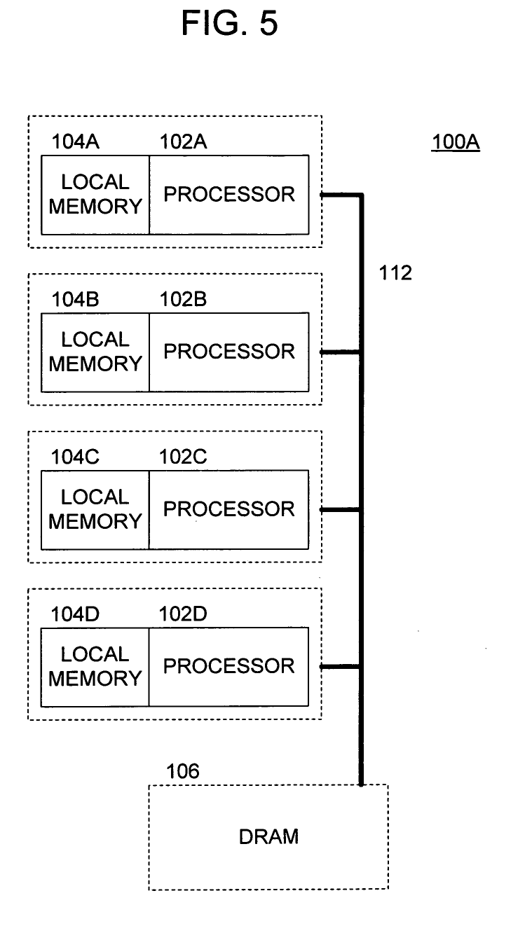

While some processing systems employ a single processor to achieve fast processing speeds, such as that illustrated and described hereinabove with respect to FIG. 1, other processing systems are implemented utilizing multi-processor architectures. With reference to FIG. 5, a multi-processor system 100A is contemplated in which, a plurality of sub-processors can operate in parallel (or at least in concert) to achieve desired processing results. The processing system 100A includes a plurality of processors 102A, 102B, 102C, and 102D, it being understood that any number of processors may be employed without departing from the spirit and scope of the invention. The processing system 100A also includes a plurality of local memories 104A, 104B, 104C, 104D and a shared memory 106. At least the processors 102, the local memories 104, and the shared memory 106 are preferably (directly or indirectly) coupled to one another over a bus system 112 that is operable to transfer data to and from each component in accordance with suitable protocols.

Each of the processors 102 may be of similar construction or of differing construction. The processors may be implemented utilizing any of the known technologies that are capable of requesting data from the shared (or system) memory 106, and manipulating the data to achieve a desirable result. For example, the processors 102 may be implemented using any of the known microprocessors that are capable of executing software and/or firmware, including standard microprocessors, distributed microprocessors, etc. By way of example, one or more of the processors 102 may be a graphics processor that is capable of requesting and manipulating data, such as pixel data, including gray scale information, color information, texture data, polygonal information, video frame information, etc.

One or more of the processors 102 of the system 100A may take on the role as a main (or managing) processor. The main processor may schedule and orchestrate the processing of data by the other processors.

The system memory 106 is preferably a dynamic random access memory (DRAM) coupled to the processors 102 through a memory interface circuit (not shown). Although the system memory 106 is preferably a DRAM, the memory 106 may be implemented using other means, e.g., a static random access memory (SRAM), a magnetic random access memory (MRAM), an optical memory, a holographic memory, etc.

Each processor 102 preferably includes a processor core and an associated one of the local memories 104 in which to execute programs. These components may be integrally disposed on a common semi-conductor substrate or may be separately disposed as may be desired by a designer. The processor core is preferably implemented using a processing pipeline, in which logic instructions are processed in a pipelined fashion. Although the pipeline may be divided into any number of stages at which instructions are processed, the pipeline generally comprises fetching one or more instructions, decoding the instructions, checking for dependencies among the instructions, issuing the instructions, and executing the instructions. In this regard, the processor core may include an instruction buffer, instruction decode circuitry, dependency check circuitry, instruction issue circuitry, and execution stages.

Each local memory 104 is coupled to its associated processor core 102 via a bus and is preferably located on the same chip (same semiconductor substrate) as the processor core. The local memory 104 is preferably not a traditional hardware cache memory in that there are no on-chip or off-chip hardware cache circuits, cache registers, cache memory controllers, etc. to implement a hardware cache memory function. As on chip space is often limited, the size of the local memory may be much smaller than the shared memory 106.

The processors 102 preferably provide data access requests to copy data (which may include program data) from the system memory 106 over the bus system 112 into their respective local memories 104 for program execution and data manipulation. The mechanism for facilitating data access may be implemented utilizing any of the known techniques, for example the direct memory access (DMA) technique. This function is preferably carried out by the memory interface circuit.

In accordance with at least one further aspect of the present invention, the methods and apparatus described above may be achieved utilizing suitable hardware, such as that illustrated in the figures. Such hardware may be implemented utilizing any of the known technologies, such as standard digital circuitry, any of the known processors that are operable to execute software and/or firmware programs, one or more programmable digital devices or systems, such as programmable read only memories (PROMs), programmable array logic devices (PALs), etc. Furthermore, although the apparatus illustrated in the figures are shown as being partitioned into certain functional blocks, such blocks may be implemented by way of separate circuitry and/or combined into one or more functional units. Still further, the various aspects of the invention may be implemented by way of software and/or firmware program(s) that may be stored on suitable storage medium or media (such as floppy disk(s), memory chip(s), etc.) for transportability and/or distribution.

As discussed above, various aspects of the present invention provide for the regulation of access to the resources of the processing system by requiring the presentation of usage information, such as an authentication code and/or digital signature to the processing system. In return for payment, an authorizing entity (such as the designer/manufacturer of the processing system) may provide a private key of a private/public key pair to the content provider. The provider may run a known hash algorithm on the content to get a hash result and then encrypt the content and the hash result. As the operating system of the processing system may readily control whether certain resources are enabled to a program, the processing system may prevent the content from using certain resources unless: (1) the content and the hash result can be decrypted using the public key of the private/public key pair, and (2) the hash result matches an independently run hash of the content.

Advantageously, the methods and apparatus for managing processing resources in a processing system in accordance with the various aspects of the present invention permit the benefits of an open system architecture (e.g., encouragement of new and more advanced content) while also permitting the designer/manufacturer of the processing system to share in the rewards of content development and sales.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. An apparatus, comprising:
a memory for storing content including program code and data;
a processor operatively coupled to the memory and being operable to request at least some of the content for execution; and
one or more, processing resources operable to facilitate the execution of the program code,
wherein the processor is operable to prevent use of one or more of the processing resources unless the content includes an authorized digital signature.

2. The apparatus of claim 1, wherein at least one of:
the processor is operable to permit execution of at least some of the program code despite the absence of the authorized digital signature; and
the processor is operable to permit use of at least one of the processing resources despite the absence of the authorized digital signature.

3. The apparatus of claim 1, wherein at least one of:
the processing resources include a non-volatile memory sub-system, and one or more functional circuits of the apparatus;
the non-volatile memory sub-system includes at least portions of software and/or hardware components of an electromagnetic memory medium, an electronic memory medium, a silicon memory medium, an optical memory medium, a hard disc memory medium, a CD-ROM memory medium, a DVD-ROM memory medium, and an external memory medium;
the one or more functional circuits of the apparatus includes at least one graphics processing circuit, a network interface circuit, and a local data input and/or output interface.

4. An apparatus, comprising:
a memory operable to receive encrypted content including program code, data, and a digital signature, the content being encrypted using a first key; and
a processor operable to decrypt the encrypted content using a second key stored locally within the apparatus, retrieve the digital signature from the content, and verify authenticity of the digital signature,
wherein an operating system of the processor is operable to permit use of one or more processing resources that are operable to facilitate the execution of the program code if the digital signature is authentic.

5. The apparatus of claim 4, wherein:
the digital signature includes a hash result obtained by running a hash algorithm on at least a portion of the content prior to encrypting the content;
the processor is further operable to: (i) execute the hash algorithm on the portion of the decrypted content to obtain a second hash result, and (ii) compare the hash result of the digital signature with the second hash result to verifying its authenticity.

6. The apparatus of claim 4, wherein:
the content includes a resource list that identifies which of the processing resources are permitted to be used by the program code; and
the processor is further operable to permit use of the listed processing resources upon verification of the digital signature.

7. The apparatus of claim 4, wherein the first key and the second key form a private/public encryption key pair.

8. The apparatus of claim 4, wherein the processor is further operable to at least one of: (i) permit execution of at least some of the program code despite absence of and/or a non-authentic digital signature, and (ii) permit use of at least one of the processing resources despite absence of and/or a non-authentic digital signature.

9. The apparatus of claim 4, wherein at least one of:
the processing resources include a non-volatile memory sub-system, and one or more functional circuits of the apparatus;
the non-volatile memory sub-system includes at least portions of software and/or hardware components of an electromagnetic memory medium, an electronic memory medium, a silicon memory medium, an optical memory medium, a hard disc memory medium, a CD-ROM memory medium, a DVD-ROM memory medium, and an external memory medium; and
the one or more functional circuits of the apparatus includes at least one graphics processing circuit, a network interface circuit, a display interface circuit, a printer interface circuit, and a local data input and/or output interface.

10. An apparatus including a processing system operable to execute software that causes a processor of the system to execute actions, comprising:
receiving encrypted content including program code, data, and a digital signature in a memory of a processing system, the content being encrypted using a first key;
decrypting the encrypted content using a second key stored locally within the processing system;
retrieving the digital signature from the content and verifying its authenticity; and
permitting use of one or more processing resources that are operable to facilitate the execution of the program code by a processor of the processing system if the digital signature is authentic.

11. The apparatus of claim 10, wherein:
the digital signature includes a hash result obtained by running a hash algorithm on at least a portion of the content prior to encrypting the content;
the actions further comprise: (i) running the hash algorithm on the portion of the decrypted content to obtain a second hash result, and (ii) comparing the hash result of the digital signature with the second hash result to verifying its authenticity.

12. The apparatus of claim 10, wherein:
the content includes a resource list that identifies which of the processing resources are permitted to be used by the program code; and
the method further comprising permitting use of the listed processing resources upon verification of the digital signature.

13. The apparatus of claim 10, wherein the first key and the second key form a private/public encryption key pair.

14. The apparatus of claim 10, further comprising:
permitting execution of at least some of the program code despite absence of and/or a non-authentic digital signature; and
permitting use of at least one of the processing resources despite absence of and/or a non-authentic digital signature.

15. A method, comprising:
storing content including program code and data in a memory of a processing system;
requesting at least some of the content for execution by a processor operatively coupled to the memory; and
preventing use of one or more processing resources that are otherwise operable to facilitate the execution of the program code, despite being called for by the program code, unless the content includes an authorized digital signature.

16. The method of claim 15, further comprising:
permitting execution of at least some of the program code despite the absence of the authorized digital signature; and
permitting use of at least one of the processing resources despite the absence of the authorized digital signature.

17. The method of claim 15, wherein at least one of:
the processing resources include a non-volatile memory sub-system, and one or more functional circuits of the apparatus;
the non-volatile memory sub-system includes at least portions of software and/or hardware components of an electromagnetic memory medium, an electronic memory medium, a silicon memory medium, an optical memory medium, a hard disc memory medium, a CD-ROM memory medium, a DVD-ROM memory medium, and an external memory medium; and
the one or more functional circuits of the apparatus includes at least one graphics processing circuit, a network interface circuit, a display interface circuit, a printer interface circuit, and a local data input and/or output interface.

18. The method of claim 15, further comprising:
requesting information from an entity associated with the processing system to facilitate providing the authorized digital signature with the content in exchange for consideration from an entity requesting the information.

19. The method of claim 18, wherein the entity associated with the processing system is at least one of a designer and manufacturer of the processing system.

20. The method of claim 18, wherein:
the entity requesting the information is a content provider; and
the consideration is monetary payment for permitted use of one of more of the processing resources of the processing system.

21. The method of claim 18, wherein the requested information includes at least one of an encryption key and digital signature information.

22. The method of claim 21, wherein: the digital signature information includes at least the identification of a hash algorithm to which at least some of the content is subject to produce a hash result used as at least part of the authorized digital signature.

23. The method of claim 21, further comprising:
including the authorized digital signature with the content;
encrypting the content with the encryption key; and
transmitting the encrypted content to the processing system.

24. The method of claim 21, further comprising: including a resource list with the content that identifies which of the processing resources are permitted to be used by the program code.

25. A method, comprising:
receiving encrypted content including program code, data, and a digital signature in a memory of a processing system, the content being encrypted using a first key;
decrypting the encrypted content using a second key stored locally within the processing system;
retrieving the digital signature from the content and verifying its authenticity; and
permitting use of one or more processing resources that are operable to facilitate the execution of the program code by a processor of the processing system if the digital signature is authentic.

26. The method of claim 25, wherein:
the digital signature includes a hash result obtained by running a hash algorithm on at least a portion of the content prior to encrypting the content;
the method further comprises running the hash algorithm on the portion of the decrypted content to obtain a second hash result; and
comparing the hash result of the digital signature with the second hash result to verifying its authenticity.

27. The method of claim 25, wherein:
the content includes a resource list that identifies which of the processing resources are permitted to be used by the program code; and
the method further comprising permitting use of the listed processing resources upon verification of the digital signature.

28. The method of claim 25, wherein the first key and the second key form a private/public encryption key pair.

29. The method of claim 25, further comprising:
permitting execution of at least some of the program code despite absence of and/or a non-authentic digital signature; and
permitting use of at least one of the processing resources despite absence of and/or a non-authentic digital signature.

30. The method of claim 25, wherein at least one of:
the processing resources include a non-volatile memory sub-system, and one or more functional circuits of the apparatus;
the non-volatile memory sub-system includes at least portions of software and/or hardware components of an electromagnetic memory medium, an electronic memory medium, a silicon memory medium, an optical memory medium, a hard disc memory medium, a CD-ROM memory medium, a DVD-ROM memory medium, and an external memory medium; and
the one or more functional circuits of the apparatus includes at least one graphics processing circuit, a network interface circuit, a display interface circuit, a printer interface circuit, and a local data input and/or output interface.

31. A storage medium containing a software program, the software program being operable to cause a processor to execute actions including:
receiving encrypted content including program code, data, and a digital signature in a memory of a processing system, the content being encrypted using a first key;
decrypting the encrypted content using a second key stored locally within the processing system;
retrieving the digital signature from the content and verifying its authenticity; and
permitting use of one or more processing resources that are operable to facilitate the execution of the program code by a processor of the processing system if the digital signature is authentic.

32. The storage medium of claim 31, wherein:
the digital signature includes a hash result obtained by running a hash algorithm on at least a portion of the content prior to encrypting the content;
the actions further comprise: (i) running the hash algorithm on the portion of the decrypted content to obtain a second hash result; and (ii) comparing the hash result of the digital signature with the second hash result to verifying its authenticity.

33. The storage medium of claim 31, wherein:
content includes a resource list that identifies which of the processing resources are permitted to be used by the program code; and
the actions further comprise permitting use of the listed processing resources upon verification of the digital signature.

34. The storage medium of claim 31, wherein the first key and the second key are a private/public encryption key pair.

35. The storage medium of claim 31, further comprising:
permitting execution of at least some of the program code despite absence of and/or a non-authentic digital signature; and
permitting use of at least one of the processing resources despite absence of and/or a non-authentic digital signature.
